(19) United States
(12) Patent Application Publication
(10) Pub. No.: US 2006/0008783 A1
(43) Pub. Date: Jan. 12, 2006

(54) Method of creating successful volunteer teams for organizations

(76) Inventor: Holly Whitlock-Glave, N. Barrington, IL (US)

Correspondence Address: BARNES & THORNBURG, LLP, P.O. BOX 2786, CHICAGO, IL, 60690-2786, US

(21) Appl. No.: 10/887,122

(22) Filed: Jul. 8, 2004

(51) Int. Cl. G09B 19/00

(52) U.S. Cl. 434/219

(57) ABSTRACT

A method of creating a volunteer personnel team for service in selected service positions of an organization, the method carried out by a volunteer management team formed of members of the organization, or of individuals hired by the organization. Members of the management team recruit volunteers to serve in the organization, and the recruiters meet with the prospective volunteer and an interviewer. The interviewer obtains information from the volunteer, and a suitable service position within the organization is selected for the prospective volunteer. The interviewer and the volunteer then meet with a trainer having skills in the selected service position, and the trainer subsequently trains the volunteer in the tasks necessary to properly perform in the selected service position. The volunteer then commences performing in the selected service position, initially under the guidance of a mentor who assists the volunteer to become comfortable in the selected service position. The interviewer subsequently obtains information about the comfort level of the volunteer in the selected service position. Information about each step of each volunteer's recruiting, interviewing, training and mentoring are maintained in written or electronic form, and the entire process of creating a volunteer personnel team is continually being evaluated.

### FIELD OF THE INVENTION

The present invention relates to a method of building successful volunteer teams within an organization, and more particularly to a process for selecting and training volunteers that are capable of efficiently performing their service functions within the organization.

### BACKGROUND OF THE INVENTION

Many organizations today, both profit and non-profit such as social, church, and community organizations, consistently utilize ineffective methods of recruiting and training volunteers to assist in the performance of the mission of the organization. At present, many organizations are staffed with volunteers who offer their services only out of the desire to make a difference in the community by enabling the organization to fulfill its mission. Often, these organizations are unable to consistently and successfully recruit new volunteers due to the lack of an efficient recruiting plan and a lack of available recruiting materials.

Also, once recruited, these organizations have witnessed an inability to process volunteers efficiently and quickly. For example, too much time lapses before the volunteer receives a callback after submitting his or her name as a volunteer. This leads the volunteer to become frustrated, lose motivation and, ultimately, decide not to serve as a volunteer. Many organizations have also experienced a high turnover of volunteers due to the lack of incorporating their volunteers into the culture of the organization.

Without proper recruiting, interviewing and training techniques, an organization is more than likely to place the volunteer in a position that is not well-suited for that particular person. It has been found that simply placing volunteers into open positions without taking into account their interests, talents, gifts and motivations causes the volunteers to quickly lose interest and subsequently resign from their positions. Further, volunteers are normally not fully informed of their duties, expectations, and expected commitments before they take a volunteer position within an organization.

Most organizations have no consistent formal training process for volunteer positions. This means that volunteers are left to figure out the duties of their volunteer position on their own, leading the volunteers to develop bad habits while serving as volunteers. Most organizations do not establish uniformity as to how volunteers are to serve in their positions, and no standards are set for service in volunteer positions. Unless properly trained, volunteers are more than likely to be unfamiliar with how to handle guests/customers/the public visiting an organization's facilities in a manner acceptable to and desired by the organization.

Upon starting their volunteer service, volunteers are normally apprehensive about serving, leading the volunteers to do a poor job in their positions as a result of nervousness and lack of confidence. Volunteers who are serving for the first time will most likely have unanswered questions. The volunteers who are thrown into service for the organization without proper mentoring will feel as if they have no support system upon which they can rely or from which to seek answers to questions in case of problems. Another problem occurs when volunteers are not introduced by the organization to other volunteers before they start their service.

Since a volunteer is not being paid or renumerated for his/her services, a volunteer will more than likely resign his/her position rather than seek solutions when problems arise. In most volunteer processes utilized in today's organizations, there is no follow up with volunteers once they begin their service to address any issues or questions they may have. If a volunteer's needs are not met with regard to the position in which he/she is serving ,the resulting loss of interest in the position will cause that volunteer to resign. Further, a proper volunteer program in an organization should provide a process whereby the volunteer can find another position if he/she is dissatisfied with his/her present position or have a system; in place whereby the volunteer can explore additional positions within the organization to serve as a volunteer.

If volunteers are not instilled with an understanding of the importance of their role to the organization as a whole, the volunteers will have no incentive to continue their service. A volunteer has to be made to feel important and needed. The organization must ensure that the volunteer gains a positive attitude about his/her service and that the volunteer ultimately feels like a team player. Under normal circumstances in today's organizations, no individual attention or care is given to volunteers, causing the volunteer to have no real “investment” in the whole mission of the organization.

It has further been discovered that an organization should have evaluation tools to review its volunteer process and to form a basis upon which to praise the volunteer for service well done.

In a normal organizational setting, the demanding and time consuming job of recruiting, interviewing and training volunteers is the function of only a few key leaders. It's the organization's hope that these leaders will find, place and retain the necessary number of volunteers. Organizations today use computer databases to track volunteer leads and the eventual outcome of each lead. However, organizations today do not use a disciplined system or method for recruiting, interviewing ,training and mentoring their volunteers to instill the volunteers with a desire to remain with the organization.

The select few of those in the organization who are chosen to handle volunteers are normally overloaded with other duties, such that finding and placing volunteers is given very little attention. This is because the key leaders of the organization must also oversee and direct their attention to the main functions and purposes of the organization, which normally includes among others, the raising of funds. These leaders are not given a process, tools or materials necessary to care for the volunteers, retain the volunteers or ensure that the volunteers are effectively serving in their positions once they begin. Without proper guidance, each leader must rely on his/her own limited abilities and knowledge to handle the volunteers. Even those organizations that use a database to keep a record of volunteers do not provide any significant accountability on the part of the leaders as to what happens to the volunteer leads or to the volunteers themselves once the volunteers are recruited and placed on the organizational teams.

Therefore, it is an objective of the present invention to prepare individuals for volunteer positions through a process of recruiting, interviewing, training and mentoring.

A further object of the present invention is to provide a process of recruiting, interviewing, training and mentoring volunteers that addresses and solves each of the problems set forth above.

A further object of the present invention is to provide a volunteer recruiting, interviewing, training and mentoring method that focuses on the new volunteer. In practicing the method of the invention, a volunteer management team comprising trained members of the organization, personally guide each new volunteer through a series of steps necessary to fully prepare the volunteer for service in the organization.

Another object of the present invention is to build successful volunteer teams through a process of recruiting, interviewing, training and mentoring for the advancement of the organization's mission.

### SUMMARY OF THE INVENTION

The present invention provides a structured volunteer process that includes the steps of recruiting, interviewing, training and mentoring volunteers, administered by a volunteer management team that is part of an organization desiring to utilize volunteer servers in various positions within the operation, functions and duties of the organization. The volunteer management team of the organization comprises a coordinator with overall responsibility for the success of the process, and recruiters, interviewers, trainers and mentors that guide each volunteer until the volunteer is capable of performing in a selected service position within the organization on his/her own. The process also includes steps for evaluating the effectiveness of the volunteer recruiting, interviewing training and mentoring process to allow for modifications if recurrent failure patterns are detected. In an alternate embodiment, the volunteer management team is formed outside of the organization, and then offers its services to the organization on an outside consulting basis, or other suitable arrangement.

### BRIEF DESCRIPTION OF THE DRAWINGS

FIGS. 1A and 1B are is an illustration of the two pages of one embodiment of an information recording form or “track record” used in association with the inventive process.

### DETAILED DESCRIPTION OF THE DISCLOSED INVENTION

The system forming the present invention is analogous to a relay team running in a relay race. Consider each of the members of the organization's volunteer management team, having responsibility for volunteers, as a relay runner. In this analogy, each new volunteer interested in serving within the organization is seen as the baton passed between the runners of the relay team. On an actual relay team, relay runners spend countless hours perfecting the baton exchange, an exchange that lasts only two to four seconds, because if the baton is dropped, the exchange fails and, ultimately, the race is lost. The baton exchange in our hypothetical relay race has several important features that relate to the innovative system disclosed herein. First, each runner must have a tight grip on the baton because the runner must still hold, handle and pass the baton at the required time while in a full sprint. Second, the next runner must begin running at precisely the right time as he/she sees the runner behind him/her approaching for the exchange. Third, most runners use the passing technique where one runner drives the baton into the next runners hand, forcing the next runner's hand to close around the baton. Fourth, for a one second time period during the two to four second baton pass, both runners' hands are on the baton. Fifth, a runner. passes the baton to the next runner only after his/her portion or leg of the race is completed. Sixth, the goal of all the runners on the team is to advance the baton over the finish line.

Each runner in a relay race runs a leg of the race, which is the distance run by each runner before he/she passes the baton to the next runner. In the analogy with the method forming the present invention, the recruiters are analogous to the starting runner of the relay race. The second leg of the disclosed method consists of interviewers, and the third and last runner in the inventive process are the trainers. In the inventive process, each member of the organization who is acting on the volunteer management team has chosen one of these legs in which to serve.

In the system forming an embodiment of the present invention, each member of the volunteer management team (or runner) is trained in every position within the organization in which volunteers serve. It has been found that a volunteer management team cannot effectively recruit, interview and train for volunteer positions unless each member of the volunteer management team is knowledgeable of all the details of each position and what types of persons would be best suited to serve in each position.

Recruiting

In the inventive method disclosed herein, the recruiters of the volunteer management team are the first leg in the process. In the hypothetical relay race, the recruiters must first find the batons (volunteers) prior to beginning the race (the volunteer program). To accomplish this it is recommended that recruiters participate in or become familiar with organization-wide events, including recruiting events, where they will meet other members of the organization, and possibly those persons who are interested in becoming members of the organization. The recruiters also can hold their own volunteer outreach events for the purpose of recruiting. The organization preferably designs materials directed at recruiting, such as brochures, invitations, and lead forms. Additionally, it is recommended that the recruiters and the organization maintain a website for recruiting under the organization's web page.

The recruiter's function is to be proactive in obtaining volunteers willing to perform service for the organization. To prepare him/herself for this function each recruiter is encouraged to meet with members of the volunteer management team to generate new ideas, and discuss old ideas, for successful recruiting of volunteers. The recruiters are preferably actively involved in the planning, organization and implementation of methods of recruiting, such as assisting the organization in the creation of brochures. The recruiters desirably become familiar with all of the positions in the organization requiring volunteer service, and take personal responsibility for keeping abreast of events, seminars, organization projects, and the general operations of the organization's projects and operations. The recruiter will attend meetings of the volunteer management team, and direct any team concerns to the individual or individuals in the best position to resolve such concerns.

The recruiter has specific steps to take before passing the volunteer to an interviewer, which is the next leg of the process. First, the recruiter makes contact with the volunteer by phone call or other means, which could require one or several efforts at making an initial contact. For example, the telephone call or other attempt at initial contact with the volunteer should be made within 48 hours of the recruiter obtaining information about the prospective volunteer. Under differing circumstances, a shorter or longer initial contact period may be desirable. Second, the recruiter introduces the volunteer to the organization, its mission and the primary areas in which its volunteers serve. Third, the recruiter provides the prospective volunteer with a brief overview of the various positions within the organization into which the volunteer may be placed. Fourth, the recruiter explains the volunteer placement and training process used by the organization, how it functions, and its aims. The volunteer is advised that after the recruiting meeting, the volunteer is interviewed. The recruiter schedules an interview with the prospective volunteer to take place within a reasonably short period of time, such as one week from the initial contact date, depending upon the availability of the volunteer. The volunteer is further informed by the recruiter that following the interview, the name of the volunteer will be provided to a trainer for the position the volunteer has selected. Training is conducted at the convenience of the volunteer. The volunteer is also advised that subsequent to training, he/she begins serving in the selected volunteer position, and that a team mentor will serve alongside the volunteer for as long as it takes the volunteer to feel comfortable serving on his/her own. Fifth, the last step by the recruiter is to pass the volunteer off to an interviewer after all of the above tasks have been completed. In an embodiment of the inventive process, the recruiter and the interviewer may be the same person. In such cases, the recruiter follows the steps set forth herein, but does not pass the volunteer to another person.

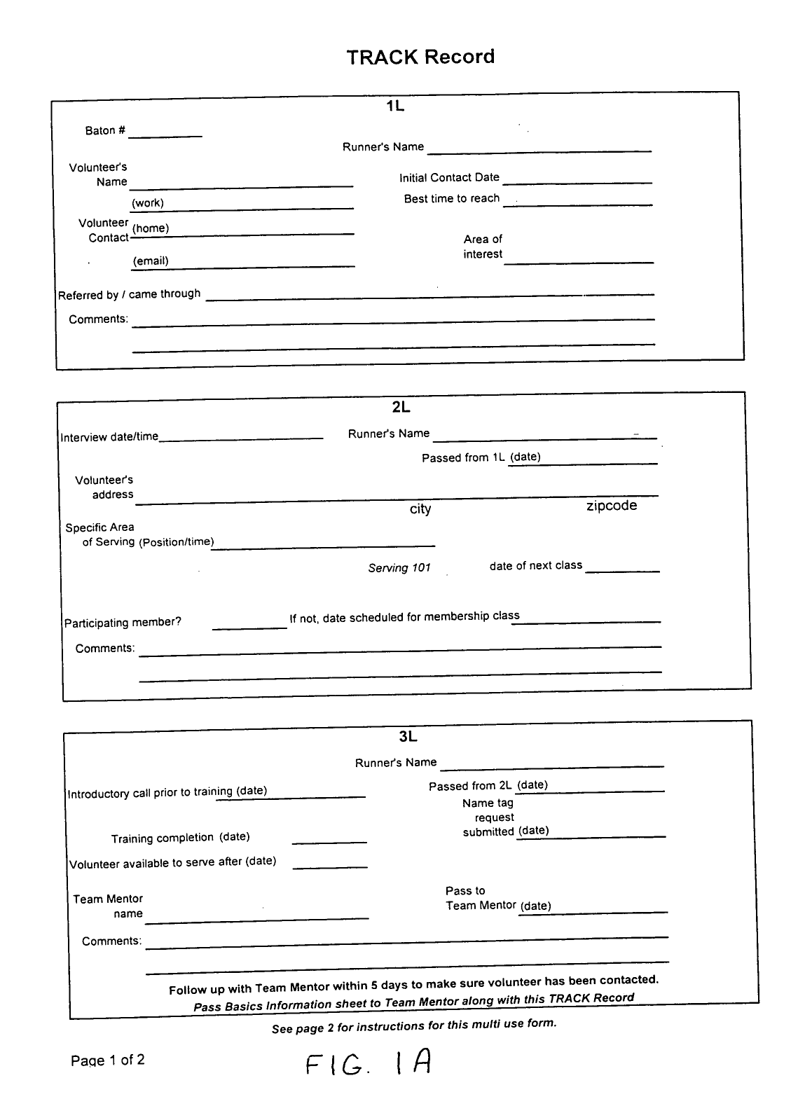

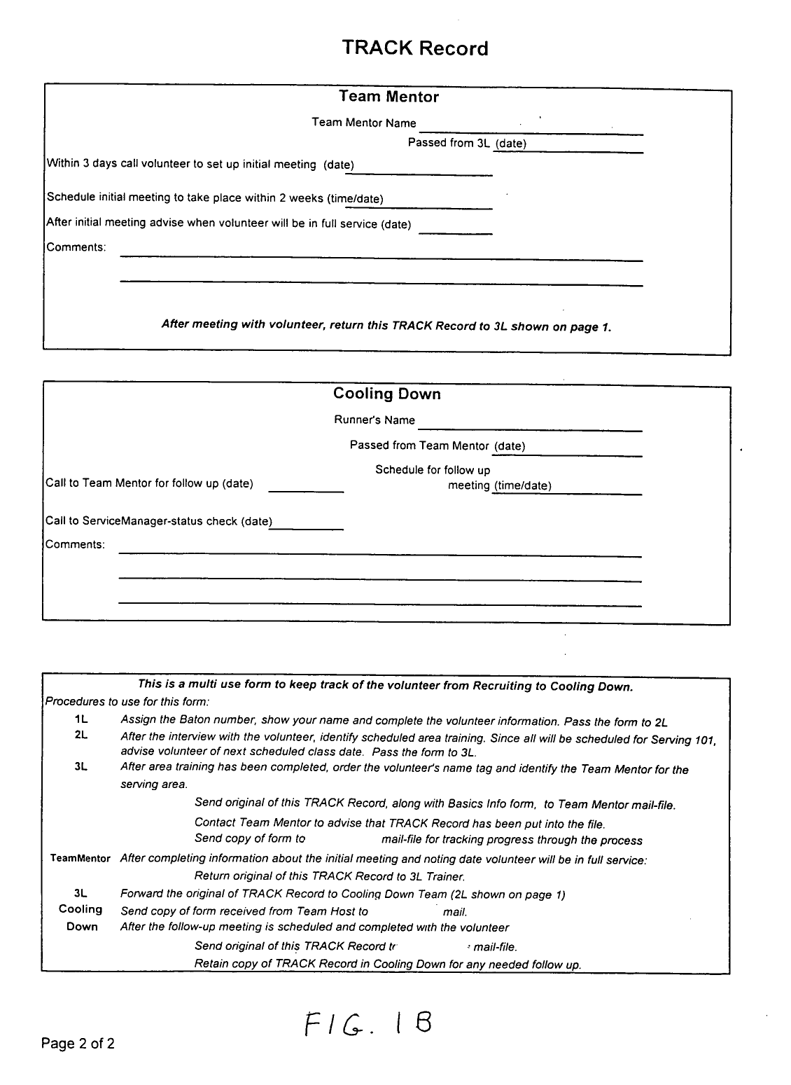

The recruiter then completes an information recording form, or “track record” form (FIGS. 1A and 1B) and sends it to the designated interviewer. The track record includes relevant information such as the volunteer identification number or indicia (baton number), the volunteer's name and contact information, the name of the recruiter, the initial contact date, the reference source for the volunteer, the volunteer's stated area of interest, and comments by the recruiter regarding the suitability and desires of the named volunteer. This information is set forth in the upper region of the track record (FIG. 1A). A track record is completed for each volunteer who enters the program.

As a volunteer passes from one step to the other, each team member, as will be explained, completes the appropriate section of the form and then actually passes the track record form to the next team member. The track record form follows the volunteer through the entire process. For example, after completing the recruiting section, the recruiter sends the track record to the designated interviewer prior to the interviewer's first meeting with the volunteer. This allows the interviewer to review the volunteer's information on the track record form prior to meeting the volunteer.

The transfer of the volunteer to the interviewer, where the interviewer is a different individual than the recruiter, according to an embodiment of the disclosed process includes a personal introductory meeting between the recruiter, the interviewer and the volunteer. At this time, the recruiter introduces the volunteer to his/her interviewer. This meeting could be brief or long, depending upon the decision of the interviewer. Prior to this meeting, the interviewer will have already received the volunteer's completed track record form, and therefore will have knowledge about the volunteer prior to actually meeting the volunteer. This should impart to the volunteer a sense of just how important he/she is to the work of the organization, which helps instill a further sense of duty and obligation in the mind of the volunteer. If time constraints make a personal meeting between the recruiter, interviewer and volunteer impractical, the introduction of the interviewer to the volunteer by the recruiter can be by phone, or any other suitable communications medium.

Interviewing

Once the recruiter has completed the steps outlined above, the pass of the volunteer to the interviewer is complete and the second leg of the process begins. The interviewer's first step in an embodiment of the disclosed process has been explained above, where the interviewer and the recruiter have a joint meeting with the volunteer to briefly introduce the volunteer to the interviewer. The interviewer has prepared for this meeting by reviewing the volunteer information on the track record form (FIG. 1) before the meeting and the exchange of responsibility for the volunteer takes place. Where the recruiter and the interviewer are the same person, that person continues with the interviewing process set forth below.

The interviewer's purpose is to embrace new volunteers with a warm and receptive attitude, reflecting the gratitude of the organization for the volunteer's decision to serve. In the second step, the interviewer conducts an interview comprising one or more sessions, with the volunteer. Through the interview of the volunteer, the interviewer assists in determining the best service position for the new volunteer, given the latter's desires, gifts, skills and talents. The interviewer is required to be knowledgeable of all the groups and positions in the organization requiring service volunteers, and all of the organization's training sessions, classes and membership processes. The interviewer also has the personal responsibility for keeping current about the events, seminars, service positions, and the general activities of the organization, and for attending meetings of the organization's volunteer management team. The interviewer's responsibilities also include directing concerns expressed by the members of the volunteer management team to those in a position to resolve such concerns, and to follow up the performance, attitude and feedback of new volunteers after they have begun serving on their own in their volunteer positions.

The interviewer begins the interview process by getting to know the volunteer, and determining the volunteer's desires and abilities in a discussion with the volunteer, and receiving feedback from the volunteer on these issues. The purpose is to determine where this particular volunteer would be best suited in working within the various positions of the organization

During the interview with the volunteer, the interviewer introduces him/herself to the volunteer and obtains background information about the length of time and degree of involvement the volunteer has had in the organization. In addition, the interviewer discusses with the volunteer in what other volunteer activities the volunteer is or has been involved and details regarding the volunteer's family, education, occupation, special interests and other relevant personal information. The interview itself is informal, with the goal being the interviewer getting to know the volunteer well enough so the interviewer and the volunteer can mutually select a service position within the organization that is best suited for the volunteer. The interviewer also discusses subjects with the volunteer pertaining to the volunteer's current and previous involvement within the organization and the motivational factors that induced the volunteer to offer to provide additional service to the organization. Also discussed are various personal traits and skills of the volunteer that factor into the decision as to the most suitable service position assignment. The availability of the volunteer to serve timewise is also discussed, and the interviewer then offers a summary to the volunteer of the recommended area(s) of service within the organization, utilizing available written information, such as brochures, prepared by the organization.

Following the interview, the third step for the interviewer is to narrow down the various choices of a suitable position for the volunteer and impart to the volunteer a detailed description of the various positions in which the volunteer's services can be utilized within the organization. The interviewer assists the volunteer in determining the service area best suited for that particular volunteer according to the skills, talents, hobbies, desires, experience and education, among other criteria, of the volunteer.

Fourth, the interviewer then provides the volunteer with any additional, pertinent information about the organization (such as membership into the organization) including the next steps to be taken by the volunteer regarding training once the volunteer chooses a position. The volunteer is also advised that the next step in the process is training, which begins with a general training program or session provided to all volunteers prior to their receiving specific training pertaining to their selected position. If the volunteer is not ready to select a service position by the conclusion of the interview, it is requested that the volunteer think about the various options for a few days, after which the interviewer will contact the volunteer to see if a decision has been reached.

Once the volunteer has chosen a position in which to serve, the interviewer's fifth and last step is to complete the second portion of the track record (FIG. 1A) and forward the track record to the designated trainer for the third leg of the process. This provides the designated trainer with the ability to review the volunteer's information before the trainer meets the new volunteer. Also, a personal exchange of the volunteer is made between the interviewer and the trainer. This is preferably a face-to-face introduction meeting between the interviewer, the trainer, and the volunteer. However, this personal exchange meeting can also be made telephonically, or by any other suitable communications medium. Also, the situation may arise where the interviewer and the trainer are the same person. In such instances, no introductory meeting is necessary to introduce the volunteer to the trainer.

Training

The purpose of the trainers is to impact the skills required to engage in a selected service position within the organization and to bring the volunteer closer to the overall culture of the organization. The trainer meets periodically with members of the volunteer management team for the purpose of creating, improving and establishing appropriate training classes and materials. The trainer also coordinates the times and locations for volunteer training sessions, applies his/her energies towards keeping abreast of all events, seminars and other activities of the organization. The trainer further directs concerns of other volunteer management team members he/she is aware of to those in the organization having the ability to address such concerns.

The first step for the trainer, prior to meeting the volunteer, is to review the volunteer information available to him/her on the track record (FIG. 1A)

Second, the trainer then ensures that the new volunteer is made aware of and successfully completes the organization's general service training session. The organization's general service training session is a course structured to be taken by all volunteers, regardless of the service position they ultimately select. This course extends over a several hour period, or larger or shorter as the needs of the organization dictate. Any type of teaching technique can be used such as lecture, video, computer slide presentations, written manuals, and/or internet delivery. Each teaching method will ensure a significant amount of interaction among and between the trainer(s) and the volunteers. The general service training session is preferably taken prior to the volunteer commencing service in the selected position, or at a reasonable time selected by the organization during the period of service.

The general service training session can take the following form, or any other form depending upon the mission of the organization:

I. Opening Session
A. Introduction of personnel and team members
B. Purposes of service within the organization
C. A review of the various service positions

II. Serving as a Team
A. Getting to know the other members of your team
B. Learning how to work together towards a common commitment

III. Challenges of a Volunteer
A. What actions turn people away
B. How to avoid those actions

IV. Customer Service
A. Outstanding customer service techniques
B. Red flags in serving others
C. Reacting versus responding

V. Developing Listening Skills (Part One)
A. Filters that hinder one's listening
B. Understanding the importance behind listening
C. Responding to body language

VI. Developing Listening Skills (Part Two)
A. Techniques for becoming a good listener
B. Listening with your heart
C. Helping people in stressful situations

VII. Proper Service
A. The motives to serve
B. Learning to serve with a proper degree of humility
C. Viewing problems as opportunities

VIII. Recap of the Important Features of Service

Third, the volunteer then completes specific training for the chosen service area under the direction of the trainer.

Each volunteer serving position has its own trainer and trainees, and its own volunteer training material specific to that particular service position. For example, if the organization in question operates a sizable religious facility there would be a separate trainer and training manual for an information booth, for ushers, for tour guides, for greeters, for food and beverage servers, and the like.

The training of a volunteer who has chosen to work in the organization's information booth is set forth herein as one example of the type of training a volunteer receives. The trainer initially provides an overview of the training, advising the volunteer of the goal of serving, what is required to serve, the resources made available by the organization to help the volunteer, and the layout of the information booth.

The volunteer is advised that his/her service position in the information booth has important goals for the organization. The volunteer must let those attending the facility know that the organization cares about them, and about their expression of interest in the mission of the organization. The training also lets the volunteer know that every interaction with a guest or attendee is an opportunity to make a first impression that the organization cares about them. The attendees are to be treated as if they were honored guests invited to the volunteer's home. This provides the attendees with a perception that the organization is a warm place to connect with others and to advance the mission of the organization. The volunteer is encouraged to leave an impression on the attendees that will lead them to the organization's facility.

The volunteer is also taught the appropriate dress code for serving in the information booth, to be on time for their service and not to leave early, to familiarize themselves with the materials such as brochures and activity schedules in the information booth, and pointers on how to display and convey a welcoming attitude towards attendees. The volunteer's training also includes suggestions to make to attendees regarding tours, meetings with organization offices and/or small groups of organization members, upcoming workshops on the organization's mission, and other activities that would be of interest to a person just coming into contact with the organization. The volunteer is also trained as to who to contact to respond to questions they cannot readily answer, handle lost and found inquiries, and how to maintain the information booth in a neat, orderly and welcoming motif.

The above is an example of how a volunteer who chose to perform service in the information booth of a hypothetical organization would be trained by a member of the volunteer management team prior to beginning his/her tour of service. As stated above, each of the other service positions in the organization has its own training regimen, which varies from service position to service position, and from organization to organization. The training for an information booth volunteer is set forth above merely by way of example, and is not deemed to cover all types of training regimens that fall within the scope of the process of the present invention.

When the training of the volunteer is completed, the fourth step for the trainer is to submit the completion of the training information regarding the volunteer (FIG. 1A) to the organization. In an embodiment of the inventive process, the trainer requests a name badge for the volunteer.

After the trainer has submitted completion of the training information for the volunteer, the trainer's fifth and last step is to pass the volunteer to the team mentor, and preferably the trainer and the team mentor hold an initial meeting with the volunteer to introduce the volunteer to the mentor, and to transition the training process to the team mentor. If the trainer and the mentor are the same person, this introductory meeting is not necessary.

Mentoring

After the recruiting, interviewing and training steps have been completed, the volunteer is ready to begin serving. However, it has been determined that the volunteer usually requires additional mentoring once in his/her service position to alleviate the volunteer's apprehension and nervousness about serving in the designated position. Therefore, a next step in the disclosed process is the designation of a team mentor, who is a person already serving in the same service position chosen by the new volunteer. The team mentor welcomes the new volunteer into the team, and additionally trains and advises the new volunteer until the new volunteer is ready to serve on his/her own and feels comfortable and secure in performing the designated functions on his/her own. In some circumstances, the mentor may be one of the persons who previously recruited, interviewed, and/or trained the volunteer.

The duties of the team mentor include serving along side of the new volunteer in the designated service position, introducing the new volunteer to other team members in the designated position and answering any remaining questions the volunteer may have.

The team mentor also explains service scheduling to the volunteer, attends meetings with the new volunteer, furnishes the new volunteer with the names and contact information about the leaders within the organization, discusses emergency procedures, and advises the new volunteer regarding any other pertinent matters related to the service position.

The mentor is not required to be a member of the volunteer management team consisting of the recruiter, interviewer and trainer because the same training is not required of a team mentor as is required for the other members. It is important however, for the team mentors to know their service position well, and not necessarily be familiar with all of the service positions within the organization. The team mentor's job is complete once the volunteer and the team mentor both conclude that the volunteer feels comfortable serving on his or her own and can complete the tasks of the particular service mission. At this point, the team mentor will complete the track record (FIG. 1B) and return it to the interviewer. In certain circumstances, it may be determined that the volunteer is working well in his/her new service position, and feels no apprehension about performing his/her service tasks. If so, the mentoring step may be eliminated.

Cooling Down

It has been determined in previous volunteer service training processes, that volunteers may be thrown into their service positions and never asked how they're doing once they have been given time to serve in their positions. One of the challenges faced in establishing an efficient volunteer service program is not only placing the volunteers in the right position, but keeping them in that position once they are there. When a volunteer is unhappy, more likely than not the volunteer quits the position. Therefore, if the above described process has not determined through the steps delineated above that the volunteer is unhappy in an embodiment of the present invention, a cooling down period may be established to determine if such a situation exists.

The cooling down period begins the day the volunteer starts serving in his or her position, and runs for a predetermined time, such as three months or so, after the starting date. In an embodiment of the invention, approximately three months after the volunteer's service date has begun, an interviewer from the volunteer management team makes a follow up call to the volunteer to ask the question: “How are you doing?” The interviewer assigned to conduct this cooling down period is the same interviewer who was in contact with the volunteer through the interviewing process set forth above. The reason for this is that the volunteer should be well acquainted with the interviewer by that time, after having been through the interview process with that particular interviewer. Desirably, the volunteer would then feel comfortable discussing with the interviewer any problems or concerns the volunteer has encountered along the way.

If the volunteer indicates that he/she is not doing well, or if the interviewer determines that the volunteer is not doing well in the selected position, the interviewer then recommends that the volunteer be sent back to whatever leg of the interviewing or training process would be most helpful to the volunteer with his/her needs at that time. It is possible that the volunteer might benefit by going through another interview process, or possibly the volunteer would benefit by additional training. It is contemplated that whatever problem surfaces, the interviewer will help the volunteer through this problem.

On the other hand, if the volunteer is performing well in the designated position, the interviewer completes the cooling down portion of the track record (FIG. 1B), and the interviewer then sends the original track record to the program coordinator. This then completes the volunteer management team process for that particular volunteer.

Evaluation Process

An embodiment of the present invention also incorporates procedures for evaluating the effectiveness and value of the entire volunteer recruiting, interviewing, training and mentoring process. First, at the time that the mentor passes the volunteer into the cooling down period, the volunteer receives a welcoming letter along with an evaluation, asking the volunteer to contribute comments as to how the organization performed during the recruiting, interviewing, training and mentoring stages of the process. The volunteer management team coordinator maintains a “baton tracking spread sheet,” which contains some or all of the following information for each volunteer:
1. The volunteer's name and contact information;
2. A “baton number” or other indicia associated with each volunteer;
3. An indication that each volunteer has completed certain portions of the program;
4. The initial contact date and the initial contact event related to that volunteer;
5. The name of the recruiter for the volunteer;
6. Comments about the volunteer's expressed interest areas;
7. Comments about the volunteer's family and the best time to meet with the volunteer. Information regarding passing the volunteer from the recruiter to the interviewer;
8. Whether or not the transfer from the recruiter to the interviewer has been completed;
9. The name of the interviewer;
10. Comments of the interviewer regarding the volunteer;
11. The volunteers chosen service area;
12. The date the volunteer was passed from the interviewer to the trainer;
13. The date the volunteer completed the organizations' basic service training course;
14. The name of the trainer and comments by the trainer on the volunteer's status;
15. Whether the volunteer has received a name tag;
16. The date the volunteer was passed to the mentor or team host;
17. The comments of the mentor or team host;
18. The initial contact date between the volunteer and the mentor or team host;
19. The date of the initial meeting between the mentor and the volunteer;
20. The date that the mentor passed the volunteer to the cooling down interviewer;
21. Information about the cooling down follow up;
22. Cooling down comments;
23. Date welcome letter sent with evaluation survey;
24. Date evaluation survey returned;
25. Dates courses within organization completed;
26. Date drop off letter sent.

The coordinator reviews the spreadsheet periodically, such as on a monthly basis, and looks for certain indicia that may indicate problems not anticipated previously, or details that require revision or adjustments. By way of example, the coordinator will be reviewing such criteria as:
1. How long it took a volunteer to get through each of the recruiting, interviewing, training and mentoring processes;
2. How long a volunteer spent with the mentor;
3. What comments were made during the cooling down period;
4. How many volunteers were sent back through the system after the cooling down period;
5. Whether a particular interviewer, trainer or mentor is developing a pattern of unhappy volunteers.

The present invention contemplates embodiments wherein the recruiting and interviewing steps may be conducted by the same member of the volunteer management team, and/or at a single meeting, or a series of meetings between the volunteer and the recruiter. Likewise, the interviewing and training steps may be conducted by the same member of the volunteer management team, however it is contemplated that under normal circumstances, the training step will extend over more than one meeting between the trainer and volunteer. If the service position requires only minimal training, the training step can be completed in one session. Also, in rare circumstances, the same person may conduct all of the steps of the present process.

The present invention also contemplates an embodiment where the interview step of the disclosed process is eliminated, and training of the volunteer commences after the recruiting step. This may occur when the size of the organization is small, and the number of service positions to be filled is limited. However, with regard to larger organizations, it is contemplated that the interview step will obtain important information from the volunteer that leads to a satisfactory choice of a service position by the volunteer.

The foregoing description of an embodiment of the invention has been presented for purposes of illustration and description, and is not intended to limit the scope of protection of the invention to the precise form disclosed. The description was selected to best explain the principles of the invention and the practical application of those principles to enable. others skilled in the art to best utilize the invention in various embodiments and various modifications as are suited to the particular use contemplated. It is intended that the scope of the invention not be limited by the foregoing specification, but be defined by the claims set forth below.

I claim:

1. A method of creating a volunteer personnel team comprising at least one volunteer to serve in a service position for an organization comprising the steps of:
a. forming a volunteer management team having at least one team member;
b. at least one of said volunteer management team members recruiting said at least one volunteer to service one of the service positions of the organization;
c. at least one of said members training at least one volunteer, each volunteer being introduced to a volunteer management team member responsible for said training by the recruiter who is acquainted with the volunteer recruited by the recruiter;
d. assigning each volunteer to serve in one of said service positions established by the organization, the service in the service position corresponding to the training received by at least one volunteer.

2. The method of claim 1, including the further step of at least one of the volunteer management team members interviewing the at least one volunteer subsequent to said step of recruiting, said at least one volunteer being introduced to said interviewer by the recruiter who is acquainted with the volunteer recruited by the recruiter.

3. The method of claim 2, including the further step of the at least one volunteer being introduced to said trainer by said interviewer subsequent to the step of interviewing the at least one volunteer.

4. The method of claim 1, wherein the volunteer management team members are trained in the functions of the service positions of the organization.

5. The method of claim 4, wherein each of the volunteer management team members is trained in the functions of each of the service positions of the organization.

6. The method of claim 1, wherein the step of recruiting volunteers includes the step of a recruiter making initial contact with the volunteer.

7. The method of claim 6, wherein the step of recruiting volunteers includes the further step of a recruiter introducing the volunteer to the organization, the mission of the organization, and an overview of the primary service positions in which the organization's volunteers serve.

8. The method of claim 7, wherein the step of recruiting volunteers includes the further step of a recruiter providing the volunteer with information regarding the service positions in the organization in which the volunteer may be placed to serve.

9. The method of claim 1, wherein the step of recruiting volunteers includes the step of a recruiter advising the volunteer of the function and aim of the volunteer placement and training process utilized by the organization.

10. The method of claim 1, wherein the step of recruiting volunteers includes the additional step of the recruiter advising the volunteer that the volunteer will be interviewed by a member of the volunteer management team.

11. The method of claim 10, including the further step of the recruiter advising the volunteer that the volunteer will be assigned a trainer for the service position selected by the e volunteer.

12. The method of claim 11, including the further step of the recruiter advising the volunteer that the volunteer will be provided a mentor subsequent to training and after the volunteer begins performing in the selected service position.

13. The method of claim 6, wherein the step of the recruiter making initial contact with the volunteer is followed by the recruiter and the volunteer conversing about the volunteer needs of the organization, the service positions available to the volunteer, and the prospective volunteer's interests in serving in the service position.

14. The method claim 13 including the step of the recruiter completing an information recording form memorizing relevant information relating to the volunteer, the recruiter completing the form subsequent to the recruiter conversing with the volunteer.

15. The method of claim 14 including the step of the recruiter furnishing the completed information recording form to the trainer.

16. The method of claim 2 wherein subsequent to the recruiter recruiting the volunteer, the recruiter completes an information recording from memorializing relevant information relating to the volunteer, and the recruiter furnishes the completed information recording form to the interviewer.

17. The method of claim 16, wherein the information recording form accompanies the volunteer as the volunteer is interviewed, is trained, and is assigned to a service position.

18. The method of claim 2, wherein subsequent to the volunteer being introduced to the interviewer by the recruiter, the interviewer conducts at least one interview with the volunteer for the purpose of ultimately determining, in conjunction with the volunteer, the most suitable service position in the organization for the volunteer.

19. The method of claim 18, wherein the interview includes a discussion of the desires and abilities of the volunteer regarding the most suitable service position in the organization for the volunteer.

20. The method of claim 18, wherein the interview includes a discussion of the time and degree of involvement the volunteer has had with the organization prior to the interview.

21. The method of claim 18, wherein the interview includes a discussion of the prospective volunteer's involvement in volunteer activities prior to and at the time of the interview.

22. The method of claim 18, wherein the interview includes a discussion of information selected from the group consisting of: the volunteer's family, education, occupation, special interests, personal information, motivational factors that induced the volunteer to desire to provide volunteer services to the organization, or any combination thereof.

23. The method of claim 18, wherein the interview includes a discussion of information selected from the group consisting of personal traits and skills of the volunteer that relate to the decision of a suitable service position within the organization, and the time the volunteer can commit to performing in a service position, or any combination thereof.

24. The method of claim 18, wherein the interview includes a discussion of recommendations by the interviewer of potential service positions within the organization that are considered suitable for the volunteer.

25. The method of claim 18, wherein the interview includes the step of the interviewer advising the volunteer that the next step in creating a volunteer personnel team is the process of training the volunteer in a selected service position.

26. The method of claim 25, wherein the interview includes the step of the volunteer selecting at least one service position within the organization in which the volunteer elects to serve.

27. The method of claim 26 including the step of the interviewer discussing with the volunteer certain recommended service positions from the at least one service position selected by the volunteer, including the step of the interviewer providing the volunteer with a detailed description of the recommended service positions within the organization.

28. The method of claim 27 including the step of the interviewer assisting the volunteer in the latter's decision to select a service position in which the volunteer desires to serve.

29. The method of claim 26, including the step of, subsequent to the interview session, the interviewer imparting to the volunteer information regarding the subsequent training steps to be taken by the volunteer after a service position is selected.

30. The method of claim 26, including the additional step of the interviewer completing an information recording form setting forth relevant information about the interview process as applied to the volunteer.

31. The method of claim 30, including the additional step of providing the completed information recording form to a designated trainer.

32. The method of claim 31, wherein the step of training the volunteer in a selected service position includes the step of the trainer reviewing the completed information recording form.

33. The method of claim 1, wherein the step of training the volunteer includes the step of the volunteer successfully completing a general service training session, which session is applicable to all service positions within the organization.

34. The method of claim 33, wherein the general service training session includes training information imparted to the volunteer on subjects selected from the group consisting of:
a. an introduction of volunteer management team members, a discussion of purposes of the organization, and an iteration of the service positions within the organization;
b. serving as a team, relating with other team members, and learning how to work together towards a common commitment;
c. actions that turn people away, and how to avoid these actions;
d. appropriate customer service techniques, warning signs in serving others, and reacting to customer service matters versus responding to customer service matters;
e. developing listening skills through learning what filters hinder one's listening, understanding the importance of listening, and responding to body language;
f. developing additional listening skills through learning techniques for becoming a good listener, and helping persons in stressful situations;
g. providing proper service by knowing the motives for serving, learning to serve with an appropriate degree of humility, and how to view problems as opportunities;
or any combination thereof.

35. The method of claim 34, wherein the step of the volunteer completing the general service training session is followed by the additional step of the volunteer completing specific training for a selected service position.

36. The method of claim 35 including the step of the trainer completing an information recording form subsequent to the volunteer completing the specific training.

37. The method of claim 1 including the step of designating a mentor assigned to the volunteer to train and advise the volunteer as the volunteer commences serving in the selected service position.

38. The method of claim 37, wherein the mentor trains and advises the prospective volunteer until the prospective volunteer is able to perform appropriately in the assigned service position.

39. The method of claim 37 including the step of the trainer introducing the volunteer to the designated mentor.

40. The method of claim 37, wherein the designated mentor has experience serving in the service position in the organization selected by the volunteer.

41. The method of claim 1 including the additional step of designating a mentor assigned to the volunteer to train and advise the volunteer as the volunteer commences performing as a volunteer in the service position corresponding to the training received by the volunteer.

42. The method of claim 41, wherein the designated mentor has experience serving in the service position corresponding to the training received by the prospective volunteer.

43. The method of claim 41 including the steps of the designated mentor serving in combination with the volunteer in the service position, introducing the volunteer to other members serving in the service position, and answering questions posed by the volunteer.

44. The method of claim 41, wherein the designated mentor furnishes information to the volunteer regarding subjects selected from the group consisting of: service scheduling, names and contact information regarding leaders in the organization, and emergency procedures regarding the service position, or any combination thereof.

45. The method of claim 41 including the step of the designated mentor terminating the training and advising step upon the designated mentor and the volunteer jointly concluding that the volunteer can complete assigned tasks of the service position without further assistance from the designated mentor.

46. The method of claim 2, wherein the step of assigning each volunteer to at least one service position is followed at a predetermined time by the interviewer individual inquiring of the volunteer how the volunteer perceives his/her progress in serving in the service position, and obtaining a response from the volunteer.

47. The method of claim 46, wherein if it is determined that the volunteer is not performing satisfactorily in the selected service position, the volunteer commences re-training related to those aspects of the training process that would be most helpful to the needs of the volunteer.

48. The method of claim 46, wherein if it is determined that the volunteer is performing satisfactorily in the related service position, the interviewer completes an information recording form with information relating to the performance of the volunteer in the selected service position.

49. The method of claim 48, wherein the completed information recording form is submitted to a volunteer team program coordinator.

50. The method of claim 41 including the additional step of evaluating the effectiveness of the steps performed by the volunteer management team recruiting, interviewing, training and mentoring steps when the mentor completes training and advising the volunteer, including the step of obtaining comments from the volunteer relating to how the volunteer management team performed.

51. The method of claim 50, wherein the additional step of evaluating the effectiveness of the steps performed by the volunteer management team includes the step of the volunteer management team maintaining a tracking document recording information about the volunteer, such information selected from the group comprising:
a. the name, contact information and an indicia designation associated with the volunteer;
b. an indication of steps of each process completed by the volunteer;
c. initial contact date and event related to the volunteer;
d. the names of the recruiter, an interviewer, the trainer and the mentor for the volunteer;
e. the volunteer's expressed interest areas;
f. the volunteer's family and recommended times for members of the volunteer management team to meet with the volunteer;
g. the meeting between the volunteer, the recruiter and an interviewer
h. completion of transfer from the recruiter to an interviewer;
i. an interviewer's comments regarding the volunteer;
j. the volunteer's selected service position;
k. any introductions between the volunteer, an interviewer, and the trainer;
l. completion by the volunteer of the organization's basic service training course;
m. comments by the trainer on the volunteer's status;
n. introduction meeting between the volunteer, trainer and mentor;
o. comments of the mentor;
p. information regarding a meeting between the volunteer, mentor and interviewer following commencement by the volunteer into service in a selected service position;
q. comments regarding the performance of the volunteer after the volunteer has commenced service in a selected service position;
r. the dates the volunteer received a welcome letter and an evaluation survey, the survey was returned, and courses within the organization completed; or any combination thereof.
